(19) United States
(12) Patent Application Publication
(10) Pub. No.: US 2013/0138530 A1
(43) Pub. Date: May 30, 2013

(54) SYSTEM AND METHOD FOR USING PURCHASING HISTORY DATA TO AUTOMATICALLY CREATE A PURCHASING LIST

(71) Applicant: Geoffry A. Westphal, Evanston, IL (US)

(72) Inventor: Geoffry A. Westphal, Evanston, IL (US)

(73) Assignee: W.W. GRAINGER, INC., Lake Forest, IL (US)

(21) Appl. No.: 13/305,362

(22) Filed: Nov. 28, 2011

(51) Int. Cl. G06Q 30/06

(52) U.S. Cl. 705/26.7

(57) ABSTRACT

Personalized product listing are generated for a user by gathering from a data repository prior product purchasing history of the user and by then analyzing the gathered prior product purchasing history of the user to discern if one or more products have been purchased according to a similar recurrence pattern. The one or more products that have been purchased according to the similar recurrence pattern are then placed within the generated personalized product listing for the user. The generated personalized product listing for the user can be used by the system to facilitate an automatic reordering of quantities of the product according to the recurrence pattern schedule.

### BACKGROUND

Systems and methods for allowing a user to manually create purchasing lists for recurring orders are known. For example, U.S. Published Patent Application No. 2011/0258072, which is incorporated herein by reference in its entirety, describes a system that allows a user to create a standing order for products or services. The standing order automatically repeats according to a recurrence pattern specified by the user. Selected products or services are sent to the user, i.e., fulfilled, at regular intervals based on the recurrence pattern. Templates may be provided to allow a user to select from a predefined product grouping where each product grouping includes one or more suggested products or services, a suggested recurrence pattern, and suggested quantities to be delivered upon each recurrence. Interactive messages may also be presented to the user to initiate the process of determining the suggested products or services and the accompanying quantities and recurrence pattern.

### SUMMARY OF THE INVENTION

The following describes a system and method for using purchasing history data to automatically create a personalized product list, particularly a personalized product list for products or services that are to be fulfilled according to a recurrence pattern. The purchasing history data may also be utilized to suggest quantities for the products or services that are to be fulfilled in accordance with the recurrence pattern.

While the forgoing provides a general explanation of the subject invention, a better understanding of the objects, advantages, features, properties and relationships of the subject invention will be obtained from the following detailed description and accompanying drawings which set forth illustrative embodiments and which are indicative of the various ways in which the principles of the subject invention may be employed.

### BRIEF DESCRIPTION OF THE DRAWINGS

For a better understanding of the subject invention, reference may be had to preferred embodiments shown in the attached drawings in which:

FIG. 1 is a block diagram illustrating components of an exemplary network system in which the subject method may be employed;

FIG. 2 illustrates an exemplary method for using prior product purchasing histories of a user to create a personalized product ordering listing;

FIG. 3 illustrates an exemplary web page providing access to a system generated personalized product ordering list; and

FIG. 4 illustrates an exemplary web page providing details associated with the products included in the personalized product ordering list.

### DETAILED DESCRIPTION

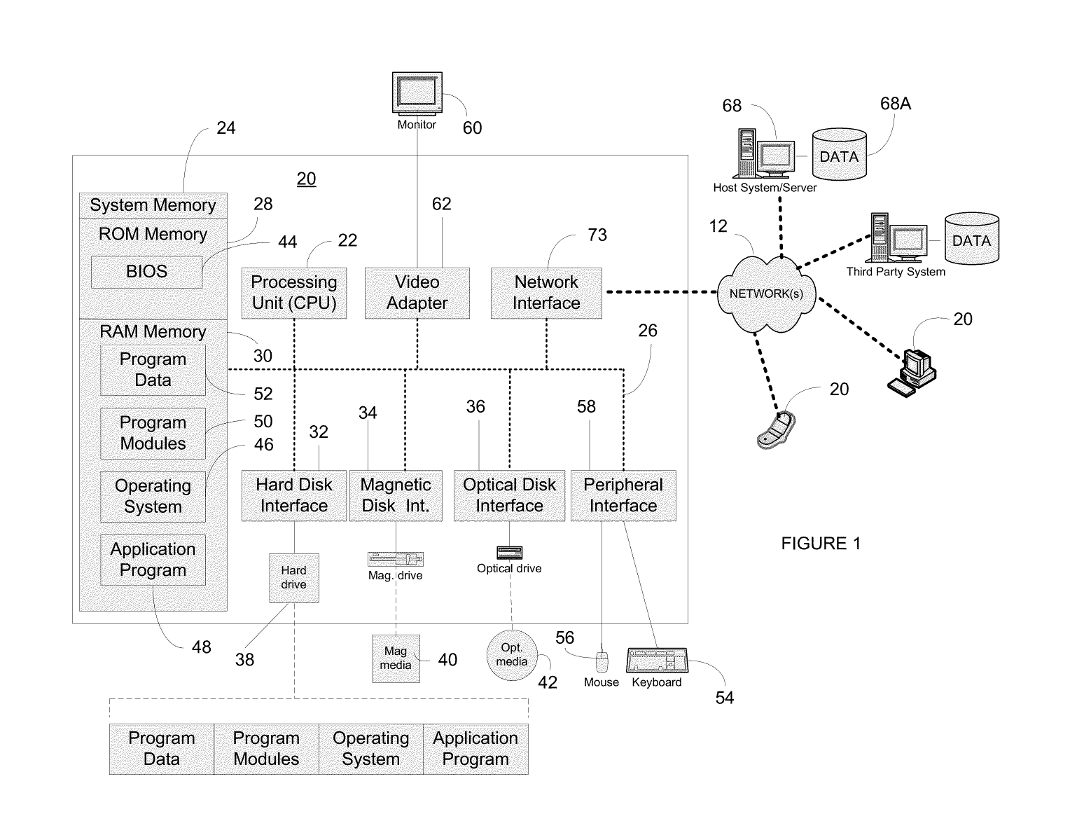

With reference to the figures, a system and method is hereinafter described for using purchasing history data to automatically create a personalized product list, particularly a personalized product list for products or services that are to be fulfilled according to a recurrence pattern. While not intended to be limiting, the system and method will be described in the context of a plurality of processing devices linked via a network, such as a local area network or a wide area network, as illustrated in FIG. 1. In this regard, a processing device 20, illustrated in the exemplary form of a device having conventional computer components, is provided with executable instructions to, for example, provide a means for a user to access a remote processing device, i.e., a server system 68, via the network to, among other things, perform a search of products and/or services, purchase products and/or services, and manage recurring orders for products and/or services (individually and collectively referred to hereinafter as “products”). Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of a single processing device 20, those skilled in the art will also appreciate that the various tasks described hereinafter may be practiced in a distributed or cloud-like environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, camera, picture editor, etc.), other program modules 50, and/or program data 52. Still further, computer-executable instructions may be downloaded to one or more of the computing devices as needed, for example, via a network connection.

A user may interact with the various application programs, etc. of the processing device, e.g., to enter commands and information into the processing device 20, through input devices such as a touch screen or keyboard 54 and/or a pointing device 56. While not illustrated, other input devices may include a microphone, a joystick, a game pad, a scanner, a camera, a gesture recognizing device, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the server system 68 having one or more associated data repositories 68A, e.g., storing product information and customer information. In this regard, while the server system 68 has been illustrated in the exemplary form of a computer, it will be appreciated that the server system 68 may, like processing device 20, be any type of device having processing capabilities. Again, it will be appreciated that the server system 68 need not be implemented as a single device but may be implemented in a manner such that the tasks performed by the server system 68 are distributed to a plurality of processing devices linked through a communication network, e.g., implemented in the cloud. Additionally, the server system 68 may have logical connections to other third party server systems via the network 12 as needed and, via such connections, will be associated with data repositories that are associated with such other third party server systems.

For performing tasks, the server system 68 may include many or all of the elements described above relative to the processing device 20. By way of further example, the server system 68 includes executable instructions stored on a non-transient memory device for, among other things, handling search requests, performing image recognition processing, providing search results, etc. Communications between the processing device 20 and the server system 68 may be exchanged via a further processing device, such as a network router that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the server system 68.

As noted above, to automatically create a personalized product list, particularly a personalized product list for products that are to be fulfilled according to a recurrence pattern, the system will have access to prior product purchasing history data for a user. In the context of this disclosure, a user may be an individual and/or a collection of related individuals such as, without limitation, individuals associated with a common corporate purchasing account. The prior product purchasing history would generally include a listing of products that have been purchased in the past by a user, the quantity of each product purchased by the user, and a time (e.g., at least a date but which may also include a time) when each product was purchased/ordered by the user. The system may additionally maintain, if applicable, a time (e.g., a least a date but which may also include a time) that each product was specified for delivery and/or pick-up by the user. Such prior product purchasing history data may be cross-referenced to a user using any known technique, such as by cross-referencing the prior product purchasing history to a user name, user log-in, user address, user credit card number, user purchasing account number, user affiliation, and/or any other system recognizable user identifier. The prior purchasing history may include products purchased from one or more of an on-line business channel, an in-store business channel, a phone channel, an email channel, a fax channel, a sales associate channel, and the like without limitation.

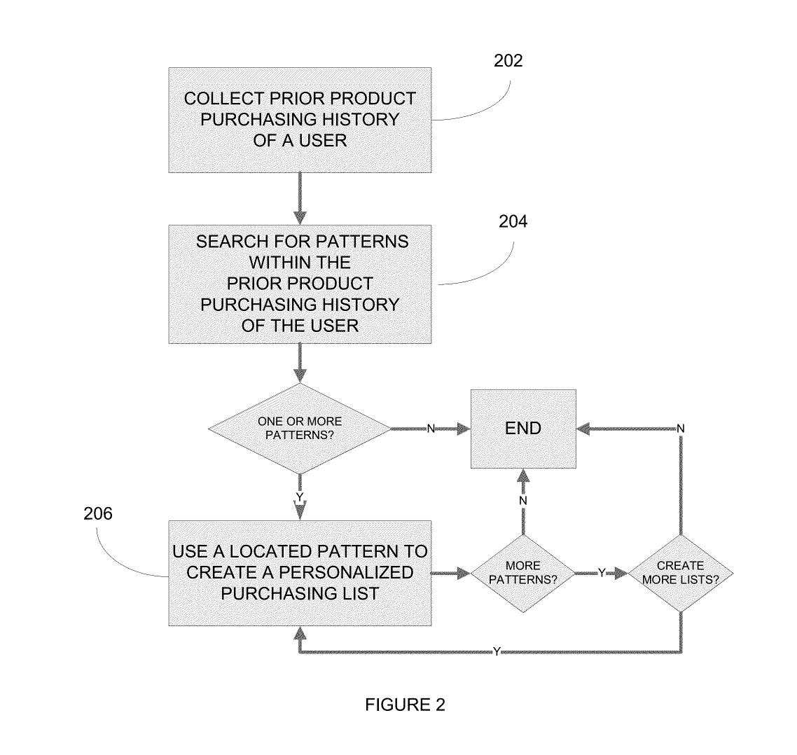

For creating a personalized product list, particularly wherein the personalized product list includes products that are to be ordered and/or delivered according to a recurrence pattern, the system 68 first gathers 202 from the data repository 68A the prior product purchasing history of the user as shown in FIG. 2. When gathering the prior product purchasing history of the user, one or more filters may be applied as desired. The filters can function to limit the prior product purchasing history gathered to one or more channels, a given period of time, a given product category, and/or the like. The gathered prior product purchasing history of the user (as filtered if filtering was applied) is then analyzed 204, using traditional statistical analysis and quantization techniques, to discern within the prior product purchasing history one or more product purchasing recurrence patterns. For example, from the prior product purchasing history of a user, the system 68 might discern that a particular product (e.g., a cleaning supply product) is being purchased (wherein “purchased” is meant to encompass ordered and/or delivered as necessary) on or around a specific date (e.g., the first Monday of the month) in a recurring pattern (e.g., monthly). As will be appreciated, by considering the date information included with the prior product purchasing history data, the system 68 can discern, with varying degrees of confidence via use of aforementioned techniques, recurrence patterns such as weekly product purchasing patterns, monthly product purchasing patterns, quarterly product purchasing patterns, yearly product purchasing patterns, seasonal product purchasing patterns, and/or considering any other time period without limitation.

Continuing with FIG. 2, if one or more recurring product purchasing patterns are discerned by the system 68, the system 68 may then function to use the prior product purchasing information (e.g., date information, product information, etc.) associated with any one or more of the discerned recurrence patterns to create 206 a personalized purchasing list. For example, the system may create a listing of some or all products that the system has discerned are purchased in a recurring pattern on or around a common date, dates, day, days, month, months, etc. The system may also add to a created listing of products additional product (which may be limited to those of the same category, e.g., cleaning supplies, or as otherwise filtered) that might have been discerned by the system as having a similar recurring purchasing pattern but which product is often purchased on or around different dates, days, months, etc. When adding such products to a created personalized product listing, the system 68 may inform the user that, if they shift their purchasing behavior for the added product, the user might be able to order the product with other products having a similar recurring purchasing pattern and thereby might be eligible for cost saving associated with shipping, discounts, etc. As will be appreciated, by filtering the prior product purchasing history data, either prior to processing as described above or thereafter, the system 68 may create any number of personalized purchasing lists in which logically related products may be aggregated.

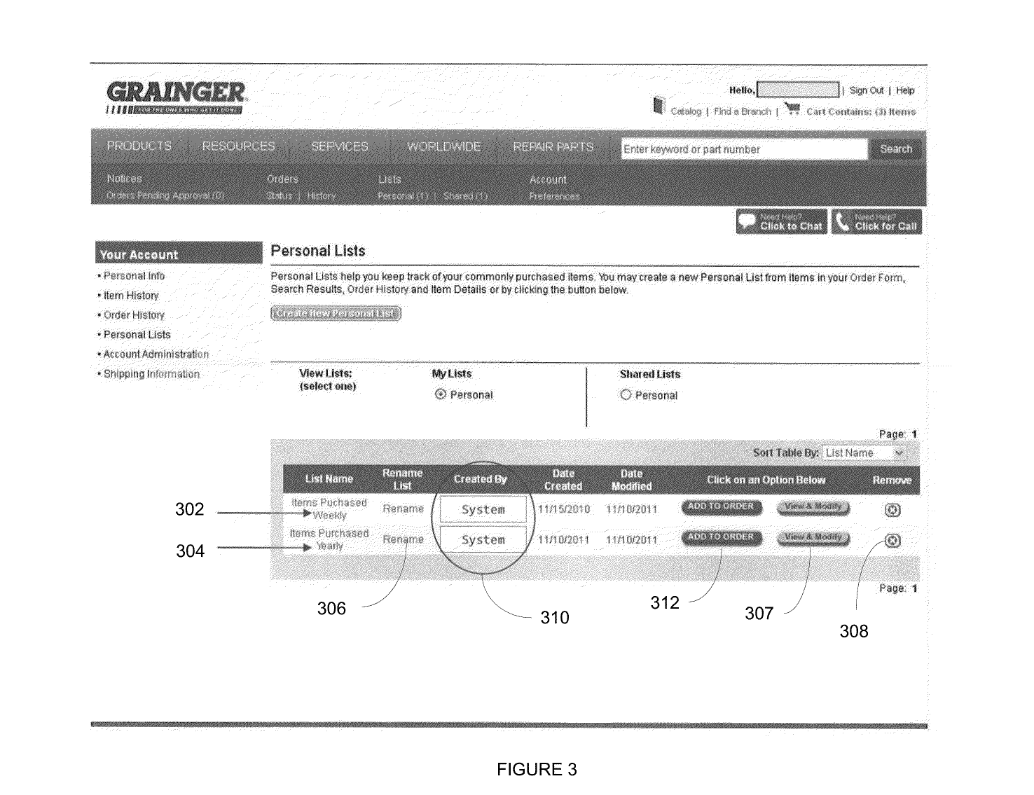

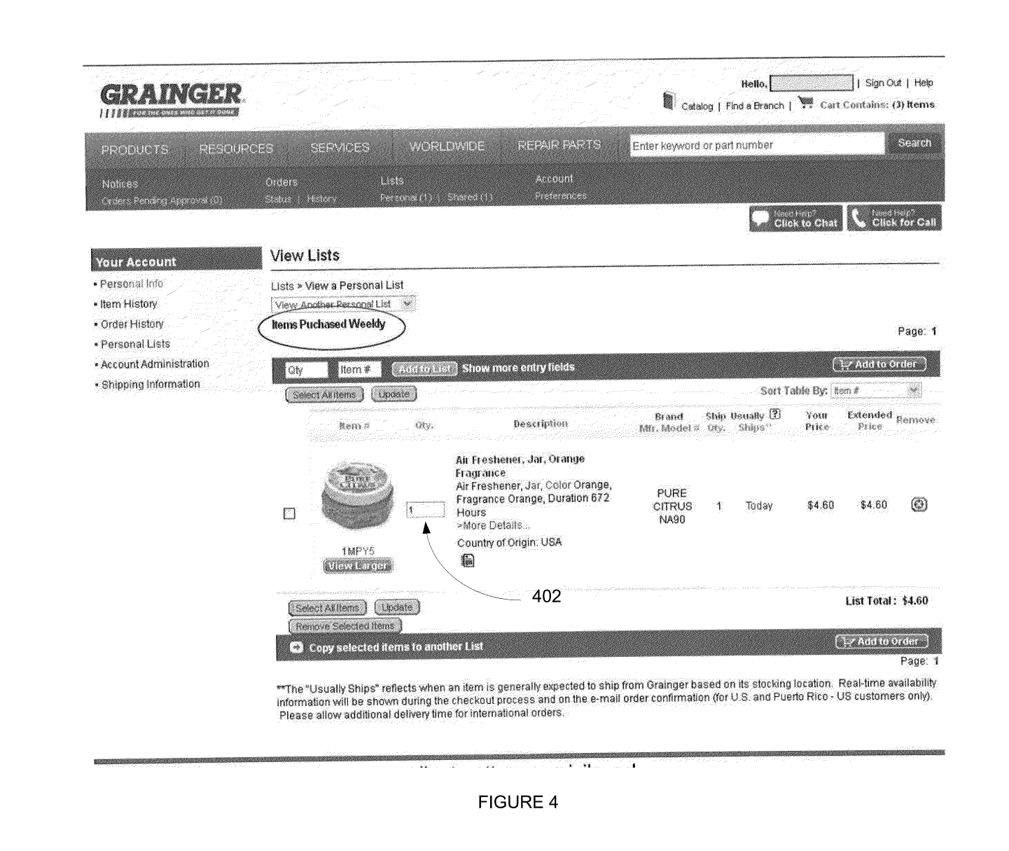

Turning now to FIGS. 3 and 4, when the system generates a personalized product list having products that are generally purchased according to a recurrence pattern, the system may make the generated personalized product list available to the user via a webpage, email, or the like. By way of the non-limiting example illustrated in FIG. 3, the system 68 may provide a “personalized lists” webpage by which the user can access their own personal lists (whether manually created or system generated) and/or personal lists created for or by others. In connection with presenting the “personalized lists,” the system 68 may also provide for the display of or access to the personalized purchasing lists generated by the system 68, e.g., a listing of product that the system has determined are being purchased in a weekly recurrence pattern 302, product that the system has determined are being purchased in a yearly recurrence pattern 304, etc. The system 68 may initially, automatically provide labels to these generated list wherein the labels would be indicative of the recurrence pattern that is associated with the product included in the listing, e.g., purchased “weekly” or purchased “yearly.” The user may then edit the label as desired, for example via activating a “rename” user interface element 306. Via the “view and modify” user interface element 307, the user may also view the generated listing and manually remove from a generated listing or add to a generated listing one or more products. The user may further request that the system generated list be removed or otherwise deleted from the system 68, e.g., via activation of the “remove” user interface element 308. The system 68 may also function to inform that user that the personalized list was generated by the system 310, the date of generation, and the date modified if any.

As further shown in FIG. 4, in connection with placing a product within a listing, the system 68 may also use the prior product purchasing history data to pre-designate a quantity 402 for the product. In this regard, the pre-designated quantity may include a mean, median, or mode of product quantity ordered in the past by the user as desired. Preferably, the pre-designated quantity can be altered by the user as necessary. In addition, the system 68 may pre-select one or more proposed purchasing dates—in keeping with the recurrence pattern—for the products within the listing which dates may also be user editable as desired. Once the user has reviewed and/or edited a generated personalized product listing, the user can then inform the system 68, for example via indicating a desire to add the listing (or product within a listing) to an order 312, that product is to be purchased as set forth in the listing, e.g., according to the recurrence pattern indicated with the product to be ordered in the quantity amounts indicated and on the date(s) indicated. The system 68 may then take the steps necessary to automatically fulfill the recurring order(s) until such time as the user modifies or otherwise indicates a desire that no further action is to take place with respect to a recurring order.

It will additionally be understood that the recurring order discernment procedure can be performed at the request of the user and/or automatically by the system, for example annually, monthly, weekly, etc. Similarly, it will be understood that filters can be user selectable or automatically applied by the system to possibly generate plural suggested listings. Thus, it will be understood that the system provides an improved mechanism for allowing users to have lists generated to thereby facilitate easy product reordering and to better manage information.

While various concepts have been described in detail, it will be appreciated by those skilled in the art that various modifications and alternatives to those concepts could be developed in light of the overall teachings of the disclosure. For example, while various aspects of this invention have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

What is claimed is:

1. A computer-readable media embodied in a non-transient, physical memory device having stored thereon computer executable instructions for providing generating a personalized product listing for a user, the instructions performing steps comprising:
gathering from a data repository prior product purchasing history of the user;
analyzing the gathered prior product purchasing history of the user to discern if one or more products have been purchased according to a similar recurrence pattern; and
generating a personalized product listing for the user wherein the generated personalized product listing for the user includes the one or more products that have been purchased according to the similar recurrence pattern.

2. The computer-readable media as recited in claim 1, wherein the instructions function to filter the product purchasing history of the user gathered from the data repository according to a pre-determined criteria.

3. The computer-readable media as recited in claim 2, wherein the pre-determined criteria is user selectable.

4. The computer-readable media as recited in claim 1, wherein the instructions function to filter the one or more products that been purchased according to the similar recurrence pattern using a pre-determined criteria prior to including the one or more products within the generated personalized product listing for the user.

5. The computer-readable media as recited in claim 4, wherein the pre-determined criteria is user selectable.

6. The computer-readable media as recited in claim 1, wherein user input causes the instructions to perform steps for generating a personalized product listing for a user.

7. The computer-readable media as recited in claim 1, wherein a schedule is utilized to cause the instructions to automatically perform steps for generating a personalized product listing for a user.

8. The computer-readable media as recited in claim 1, wherein the personalized product listing for the user includes pre-populated, quantity reordering information for the one or more products included within the generated personalized product listing for the user.

9. The computer-readable media as recited in claim 8, wherein a mean, median, and/or mode of past purchases of the one or more products are used as the pre-populated, quantity reordering information.

10. The computer-readable media as recited in claim 1, wherein the instructions facilitate fulfillment of the one or more products with the generated personalized product listing for the user according to the recurrence pattern and a reordering quantity for the one or more products.

11. The computer-readable media as recited in claim 10, wherein the reordering quantity for the one or more products is pre-populated when the personalized product listing is generated.

12. The computer-readable media as recited in claim 11, wherein the reordering quantity for the one or more products is user editable.

13. The computer-readable media as recited in claim 10, wherein one or more dates associated with the recurrence pattern are user editable.

14. The computer-readable media as recited in claim 1, wherein the generated personalized listing is sharable via a computer network.
